(19) United States
(12) Patent Application Publication
(10) Pub. No.: US 2003/0200149 A1
(43) Pub. Date: Oct. 23, 2003

(54) System and method for facilitating network installation

(75) Inventors: Beverly Ann Gonzalez, Round Rock, TX (US); Clayton H. Walther, Austin, TX (US)

Correspondence Address: BAKER BOTTS L.L.P., One Shell Plaza, 910 Louisiana, Houston, TX, 77002-4995, US

(73) Assignee: DELL PRODUCTS L.P., Round Rock, TX

(21) Appl. No.: 10/124,137

(22) Filed: Apr. 17, 2002

(51) Int. Cl. G06F 17/60; G06F 9/445

(52) U.S. Cl. 705/26

(57) ABSTRACT

In an example process for facilitating network installation, a vendor of network components may generate a network installation package (NIP) based on a list of devices to be included in the network and a library of installation guidelines. The NIP may include multiple items of software, documentation, etc., for devices to be included in the network, as well as a network installation manager (NIM) and customized installation instructions. In a related process, the NIP may be loaded into a workstation in a network, and the NIM may explain how to connect additional devices to the network, and the NIM may push software and configuration parameters to the additional devices. Also, a planning module in the NIP may generate an export list describing additional hardware components to be ordered. A vendor may use the export list to identify additional components, such as software, to accompany the hardware components.

### TECHNICAL FIELD

The present disclosure relates in general to computer networks. In particular, this disclosure relates to a system and a method for facilitating installation of distributed information handling systems, such as storage area networks, local area networks (LANs), wide area networks (WANs), or other kinds of enterprise computing systems.

### BACKGROUND

As the value and use of information continues to increase, individuals and businesses seek additional ways to process and store information. Among the options available to users are information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

A typical networking system allows the computers and other devices in the network to share resources. For example, a central file server may provide a common data repository for multiple hosts. Many different types of hardware and software may be combined to make many different kinds of networks. However, to operate properly, the hardware and software components in any particular network should be compatible with one another.

For example, enterprise computing systems such as storage area networks (SANs) can involve very complex topologies, and users may experience problems if certain aspects of the SAN hardware and software configurations do not have the proper characteristics. For instance, problems may be experienced if the devices are not connected properly to the network, or if the software components in the devices are not at the levels or revisions which are expected for proper interoperation.

Currently, a network administrator typically determines how to install and configure a network by referring to multiple pieces of documentation, each of which may provide interconnection rules, software installation instructions, or device configuration instructions for one particular type of hardware or software in the network. Furthermore, networks frequently include many different kinds of components. The network administrator may therefore need to piece together the interconnection rules, software installation instructions, etc., from many different sources (e.g., from different reference manuals for each different kind of component). In addition, the network administrator may need to visit different locations to manually configure different devices in those locations.

Consequently, in complex networks, network installation is frequently very time consuming, labor intensive, and prone to inaccuracies or errors. As recognized by the present invention, a need therefore exists for improved means for facilitating network installation.

### SUMMARY

The present disclosure relates to a system, a method, and software for facilitating network installation. According to one example embodiment, a vendor of network components may generate customized installation instructions for installing a network, based on a list of devices to be included in the network and a library of installation guidelines. The installation guidelines may be encoded in a markup language. The vendor may also identify multiple software packages, multiple documentation packages, and configuration parameters for two or more of the devices to be included in the network, based on the list of devices and the library of installation guidelines. The customized installation instructions, the multiple software packages, the multiple documentation packages, and the configuration parameters may be stored in a network installation package. The network installation package may be sent to a customer for use in installing the network.

According to another embodiment, a network installation package may include documentation, software, and configuration parameters for multiple network devices. The software and configuration parameters may have been pre-validated as successfully interoperating in a test network. The network installation package may also include network installation instructions. The network installation package may be loaded into a workstation in a network, and the network installation instructions may describe how to connect additional devices to the network. In addition, the workstation may push software and configuration parameters to additional devices in the network via a network connection in response to user interaction with one or more data items displayed in the workstation. User interaction with the workstation may also cause the software that was pushed to the additional devices to be launched.

Various embodiments may allow the vendor to efficiently build packages of deliverable components, based on customer orders, and embodiments may include additional or alternative features to those described above. For example, in an embodiment for facilitating build-to-order processing of customer orders, a network installation package may include a planning module and an export engine. The customer may use the planning module to select additional hardware components to be added to the network, and the customer may use the export engine to generate an export list describing those additional hardware components. A vendor may receive the export list from the customer and identify additional components, such as software, to accompany the hardware components. The vendor may then supply the customer with the selected hardware components and the identified software components.

### BRIEF DESCRIPTION OF THE DRAWINGS

The present disclosure and its numerous objects, features, and advantages may be better understood by reference to the following description of an example embodiment and the accompanying drawings, in which:

FIG. 1 presents a block diagram of an example storage area network;

FIG. 2 depicts a block diagram of an example embodiment of a management station within the storage area network of FIG. 1;

FIG. 3 depicts a block diagram which summarizes how various components interact in a process for facilitating network installation according to an example embodiment of the present invention;

FIG. 4 presents a flowchart of an example embodiment of a process for facilitating network installation according to the present invention;

FIG. 5 depicts an example a file of installation procedures for use in generating network installation packages;

FIG. 6 depicts an example predefined set of valid device attributes for use in generating network installation packages and performing network validation;

FIG. 7 depicts an example file of customized instructions for installing a particular network; and

FIGS. 8 and 9 depict example user interface screens produced in the management station of FIG. 2.

### DETAILED DESCRIPTION OF AN EXAMPLE EMBODIMENT

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, read only memory (ROM), and/or other types of nonvolatile memory. Additional components of the information handling system may include one or more disk drives, one or more network ports for communicating with external devices, and various input and output (I/O) devices, such as a keyboard, a mouse, and a video display. The information handling system may also include one or more buses operable to transmit communications between the various hardware components.

The present invention relates to a system, a method, and software for facilitating network installation. In particular, for purposes of illustration, this disclosure describes an example embodiment that facilitates installation of storage area networks (SANs). However, the present invention may also be used to facilitate installation of other types of distributed information handling systems or networks.

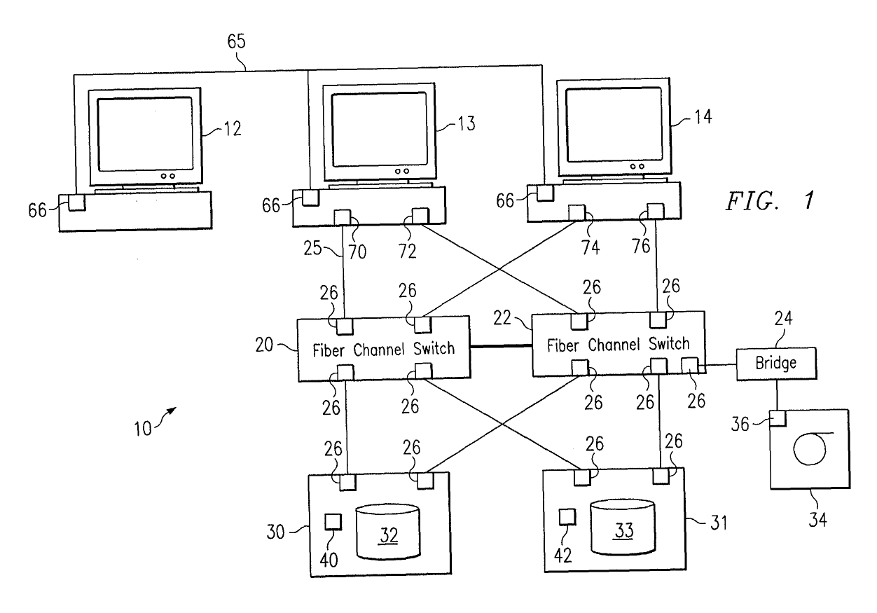

Referring now to FIG. 1, an example distributed information handling system 10 is used to illustrate various aspects of the invention and various additional or alternative features of the invention. Distributed information handling system 10 may also be referred to as network 10 or SAN 10. SAN 10 includes multiple workstations 12, 13, and 14. Each workstation may contain its own set of processors, I/O ports, and other components. Workstations 12-14 may also be referred to as information handling systems or hosts.

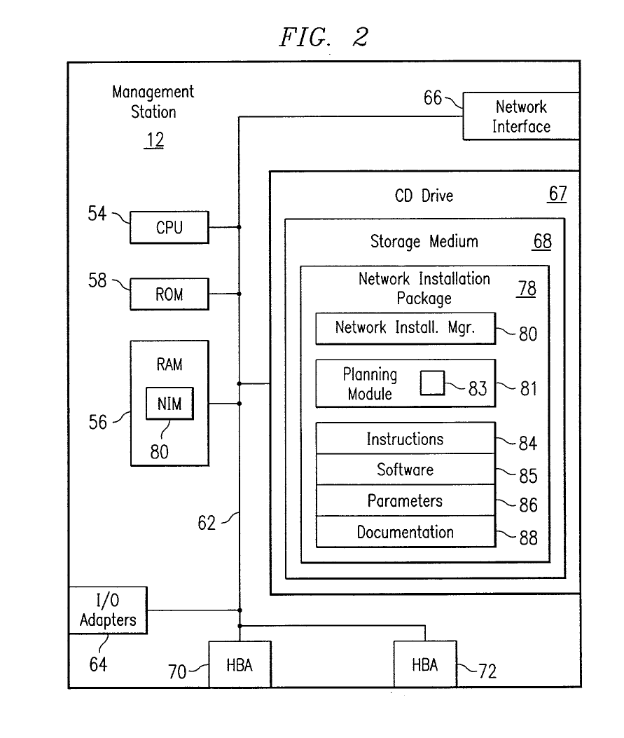

For instance, referring now to FIG. 2, workstation 12 may be used as a management station 12 in the example embodiment. Management station 12 may include one or more system buses 62 interconnecting various system components, such as one or more central processing units (CPUs) 54, random access memory (RAM) 56, and read only memory (ROM) 58. System buses 62 may also lead to I/O adapters 64 for sending output to and receiving input from devices such as a keyboard, a mouse, and a display. In addition, system buses 62 may connect to various network ports or interfaces, including network interface 66 for communicating with a local area network. Management station 12 may also include an interface for a removable storage medium 68 such as CD-ROM or DVD disks. Removable storage medium 68 may include a network installation package 78, and network installation package 78 may include a network installation manager 80 and auxiliary content for use in installing SAN 10, as explained in greater detail below.

Referring again to FIG. 1, once SAN 10 has been installed and configured, workstations 12-14 may be interconnected via a communications medium 65 and respective network interfaces 66, and workstations 13 and 14 may be used as managed nodes. Workstations 13 and 14 may include hardware that is the same as or similar to the hardware in management station 12, or one or more of workstations 13 and 14 may include different hardware. For example, workstations 13 and 14 may lack support for removable storage media but may include host bus adapters (HBAs) for communicating with storage devices in SAN 10.

For example, once SAN 10 has been installed and configured, SAN 10 may include two or more storage enclosures 30 and 31 interconnected with workstations 13 and 14 via two or more fiber channel switches 20 and 22. For instance, workstation 13 may include two HBAs 70 and 72, with each HBA connected to a port 26 on a different fiber channel switch via a fiber channel connection 25. Likewise, workstation 14 may include HBAs 74 and 76, which may connect host 14 with fiber channel switches 20 and 22, respectively. The multiple connections may provide for uninterrupted service in case any single HBA or fiber channel switch were to fail over. Fiber channel switches 20 and 22 also provide connectivity to more than one storage enclosure, as illustrated. Storage enclosures 30 and 31 may include respective storage processors 40 and 42 and respective disk drives 32 and 33. SAN 10 may also includes a tape drive 34, which may be accessed via a fiber-channel-to-SCSI bridge 24 and a SCSI port 36. Accordingly, once SAN 10 has been installed and configured, SAN 10 may provide a highly reliable and flexible environment for information storage, retrieval, and utilization.

However, as explained above, actually getting SAN 10 installed and configured may require significant expenditures of time and effort by experienced computer technicians, under conventional approaches. The example embodiment may reduce the time and effort required to install a network and may enable the installation process to be performed by less experienced personnel (e.g., by a relatively inexperienced end user or customer).

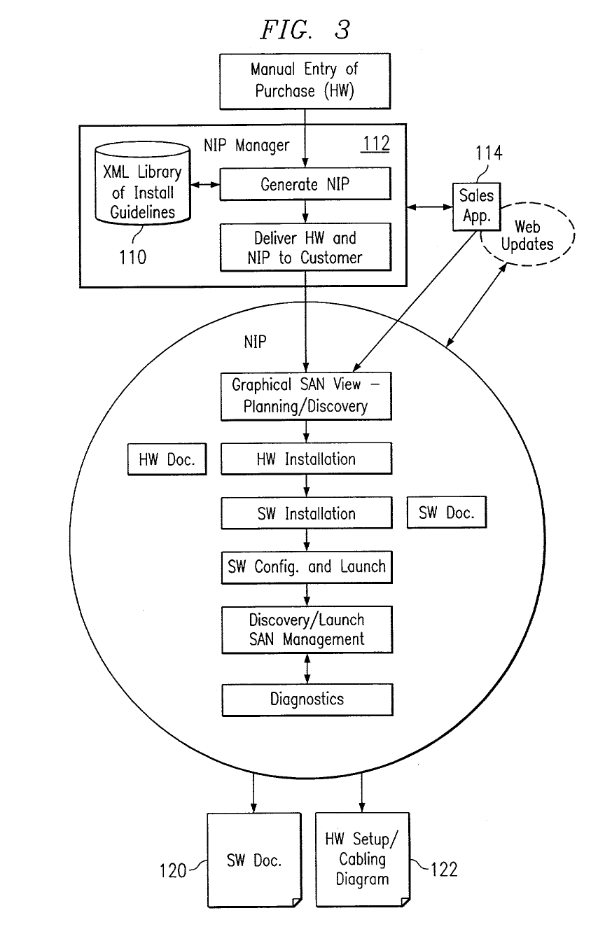

FIG. 3 depicts a block diagram that summarizes how various components may interact in a process for facilitating network installation, according to an example embodiment of the present invention. That process may begin with a customer placing an order with a vendor for various hardware components desired to create SAN.

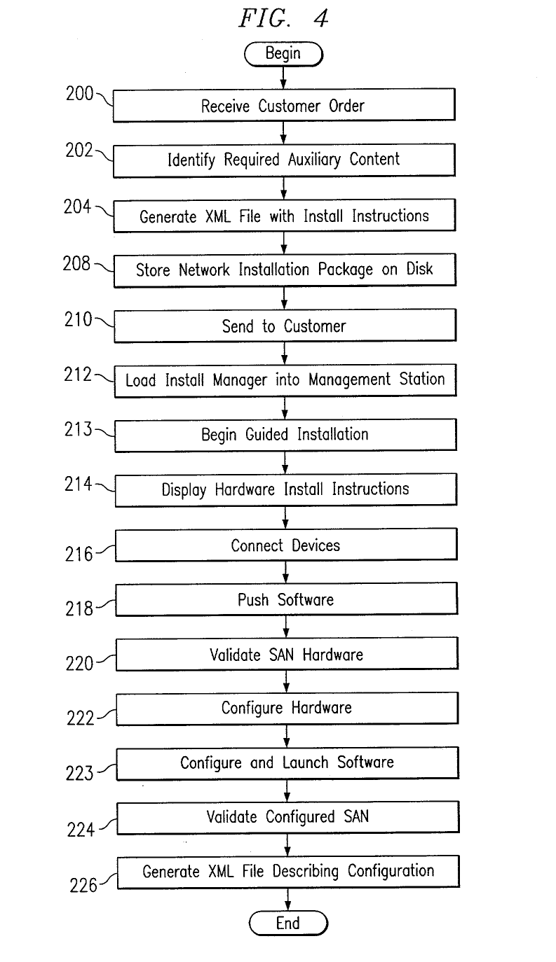

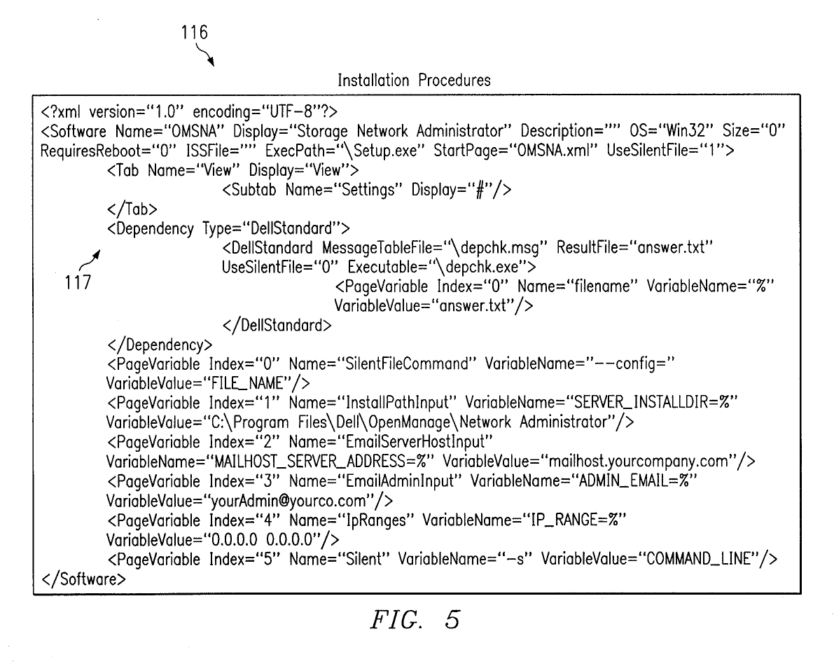

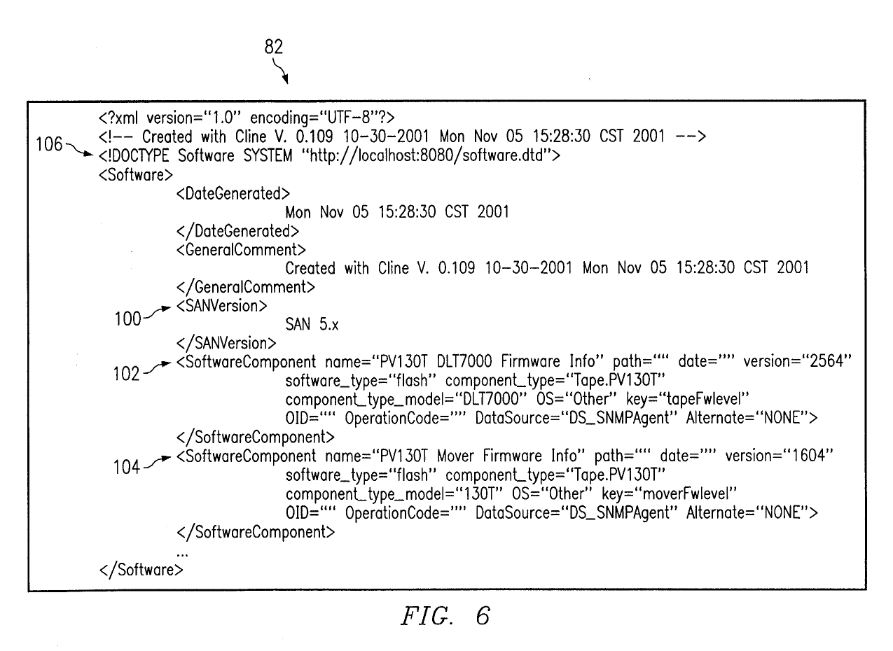

As described in greater detail below with reference to FIG. 4, the vendor may then generate a network installation package, based on the list of items in the customer order and a library of installation guidelines 110. The library of installation guidelines 110 may also be referred to as install library 110. As described in greater below with reference to FIGS. 5 and 6 install library 110 may include multiple files or modules, including a file of approved characteristics 82 and a file of installation procedures 116 for use in generating network installation package 78. The ordered components and the network installation package may then be delivered to the customer. As described below, network installation package 78 may provide for installation planning, hardware and software installation, launch of the network devices, and diagnostic validation of SAN 10.

As illustrated in FIG. 2, in one embodiment, network installation package 78 may be stored on removable storage medium 68 and delivered to the customer with the ordered network components for use in installing the network. In alternative embodiments, the network installation package may be transmitted to the customer over a communications medium such as the Internet.

FIG. 4 presents a flowchart of an example embodiment of a process for facilitating network installation according to the present invention. That process begins with a user interacting with a vendor, for instance via a sales representative or an online sales application. The sales application may also be referred to as an order processing system. At block 200, the order processing system receives a customer order specifying multiple items to be installed as a network. For example, the order may list the hardware devices illustrated as SAN 10 in FIG. 1. The customer order may or may not also include software components.

Referring now to FIGS. 3 and 4, at block 202, a NIP Manager 112 may be triggered by the order processing system 114. For instance, NIP Manager 112 may receive a list of ordered items from order processing system 114, and NIP Manager 112 may automatically identify auxiliary items required for SAN 10, such as software packages, items of documentation, and configuration parameters. If the order originally included software, NIP Manager 112 may identify additional software components required for SAN 10. The order processing system may identify the auxiliary items, based on the list of items in the customer order and on the information in install library 110, such as the file of installation procedures 116 and the file of approved characteristics 82.

As depicted in FIGS. 5 and 6, the file of installation procedures 116 and the file of approved characteristics 82 may be encoded in a markup language such as extensible markup language (XML). Accordingly, the file of approved characteristics 82 may also be referred to as XML validation rules 82. The file of installation procedures 116 may also be referred to as procedure file 116.

Procedure file 116 may include hierarchies that describe preferred sequences for installing various type of hardware and software Procedure file 116 may also include lists of software packages and configuration parameters required for various types of hardware components and combinations of hardware components and software components in a network. As depicted starting at statement 117, the hierarchies and the lists of software packages and configuration parameters my be encoded as an ordered sequence of XML statements.

As mentioned above, NIP manager may also use XML validation rules 82 to help determine which items need to be included in network installation package 78. For instance, in the example embodiment, when the customer order includes the hardware for a particular model of management station, NIP manager 112 may consult procedure file 116 to determine which software packages and items of documentation are required by that model of management station, and NIP manager 112 may then consult XML validation rules 82 to determine which version of that software and those items of documentation are required.

XML validation rules 82 may include a list of characteristics for numerous different network devices, software packages, and configuration parameters. In the example embodiment, the list of characteristics may include only characteristics that have been pre-validated as successfully interoperating in a test network. Accordingly, XML validation rules 82 may also be referred to as a predefined set of valid attributes for hardware and software components in a distributed information handling system or network.

Referring now to FIG. 6, XML validation rules 82 may include numerous different XML elements 102 and 104, and each element may list the attributes that are known to be valid for a specific type of network component. Using a markup language allows XML validation rules 82 to be easily updateable with different device attributes, once those attributes have been tested and found interoperate properly.

The predefined set of valid device attributes corresponds to various components that are known to be interoperable. For example, XML elements 102 and 103 relate to one particular type of tape drive. XML element 102 lists the valid attributes for one particular firmware module in that tape drive, and XML element 104 provides the valid attributes for a different firmware module in that tape drive. In particular, XML elements 102 and 104 specify the respective revision level for each firmware module that is known to be valid for the tape drive to inter-operate with other devices in a network. The revision level may also be referred to as the software version.

In the example embodiment, XML validation rules 82 also list a particular identifier for the overall set of valid attributes, as illustrated at XML element 100. Specifically, in the example embodiment, devices with attributes from the set of predefined valid attributes are tested prior to the release of XML validation rules 82 to verify specifically which types of devices and which software versions will effectively operate with each other. Accordingly, FIG. 6 depicts a particular set of valid device attributes identified collectively as SAN version 5.×, as shown at element 100. As network technology changes and different devices become available, a provider of network equipment or network administration services may then test a new set of devices and list the known good attributes for the new set in a new file of XML validation rules collectively identified as SAN version 6.x, for example.

NIP manager may also use the customer order and install library 110 to identify configuration parameters to be included in network installation package 78. These configuration parameters may be housed via XML to be passed to the corresponding software packages. These items will vary based on the type of installation node that is being setup and installed. These types are part of the SAN installation and validation rules.

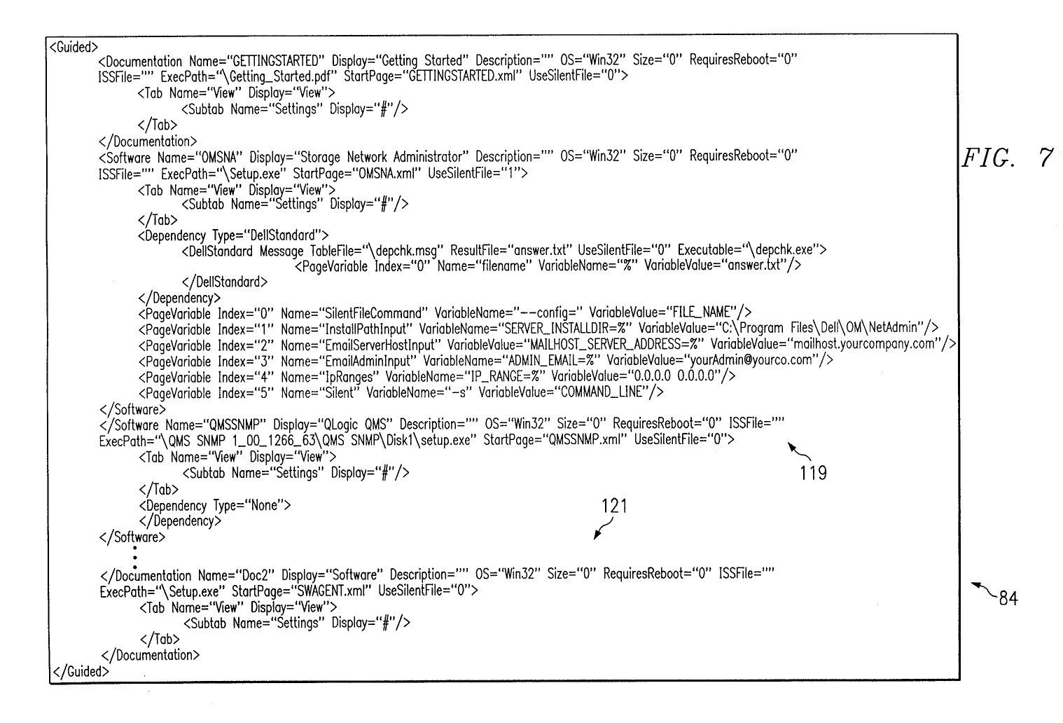

Referring now to FIGS. 4 and 7, at block 204 NIP manager 112 automatically generates an XML file with customized installation instructions 84 for SAN 10. Those instructions 84 may also be based on the ordered items and on the information in install library 110, as well as the auxiliary items that have been identified as being required for SAN 10 Specifically, in the example embodiment, when the customer order includes, for instance, SAN component ‘X’, the corresponding rules and dependencies for said component may be referenced, and the list of items needed to install and configure component ‘X’ may be made available to the user. This list of items may be compiled from install library 110.

With reference again to FIGS. 2 and 4, at block 208 NIP manager 112 then saves network installation package 78 to disk. Network installation package 78 may include the instructions 84, software 85, documentation 88, and configuration parameters 86 mentioned above. In particular, network installation package 78 may include multiple items of documentation 88, multiple software packages 85, and configuration parameters 86 for multiple network devices, as well as network installation instruction 84.

Moreover, as described above, network installation instructions 84 may have been customized for the particular hardware and software components in the ordered network. For instance, with reference to FIG. 7, XML statement 119 may cause network installation manager 80 to install the named software with the dependency and configuration parameters referred to under <Dependency . . . > and <PageVariable . . . >, respectively. If a reboot of the software is required, that can also be referenced by the ‘RequiresReboot’ flag. By contrast, XML statement 121 may cause network installation manager 80 to display or make available the associated document name, by type, as referenced in the ‘ExecPath’ setting.

The guided XML drives the software by stating what items (or steps) need to be followed, by the order they appear in the XML, to install multiple pieces of software on one server. The XML may reference all rules, dependencies, and document references needed for the user in this process. For example, in reference to FIG. 7, the XML first references a document <Documentation . . . >. The documentation reference is then followed by information to install certain pieces of software, each within the <Software . . . /Software> tabs. That information is then followed by another reference to documentation.

In addition, network installation package 78 may include software that serves as a network installation manager 80 and software that serves as a planning module 81. Network installation package 78 may be saved onto one or more disks (e.g., CD or DVD disks). Network installation package 78 also, or alternatively, may be stored on a non-removable storage medium, such as a hard disk, to be retrieved when needed, for instance via a network connection. Thus, NIP manager 112 may automatically use the customer order and install library 110 to generate network installation package 78.

At block 210 the ordered items are sent to the customer with network installation package 78. Management station 12 may then be powered up at the customer site, and network installation package 78 may be loaded, as depicted at block 212. For example, network installation manager 80 may be loaded into RAM 56 for execution by CPU 54. The various hardware and software components of management station 12 (e.g., RAM 56, CPU 54, and network installation manager 80) may be referred to collectively as processing resources. As depicted at block 213, network installation manager 80 may then begin guiding the process of installing the remaining components for SAN 10.

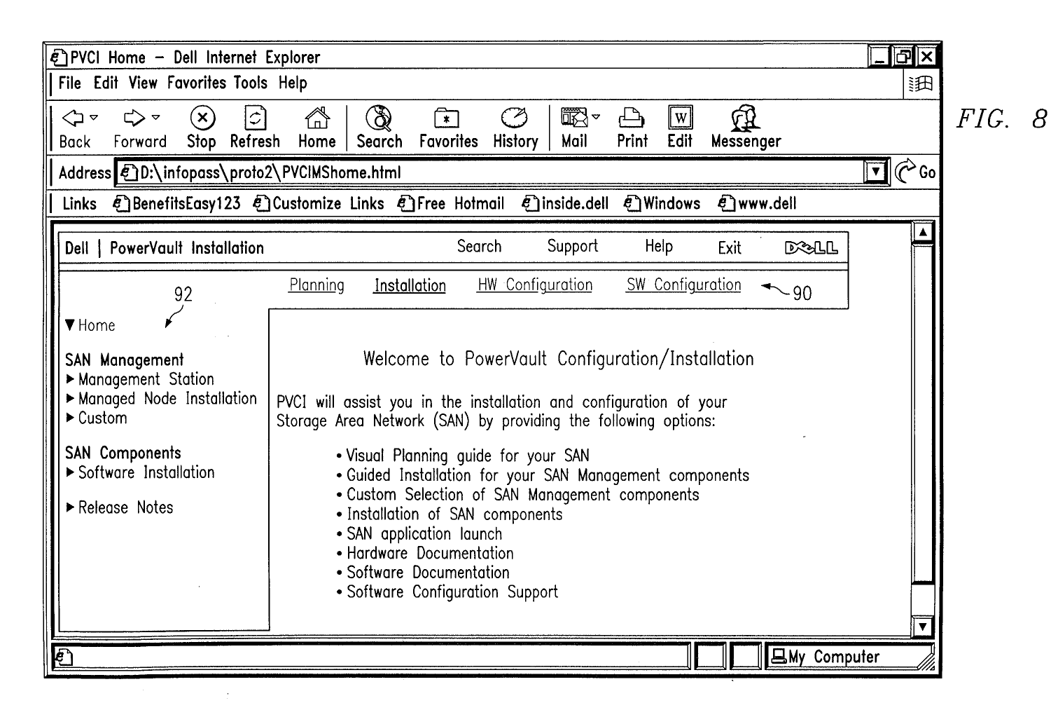

FIG. 8 depicts an example user interface screen produced in the management station by network installation manager 80. As illustrated, network installation manager 80 may display installation options in a predetermined sequence corresponding to an approved process for installing SAN 10. For instance, the user interface may use a sequence of tabs 90 listing a primary sequence of categories, such as “Planning,” “Installation,” “Hardware Configuration,” and “Software Configuration.” The screen content associated with each tab 90 may include a secondary sequence of categories listed as a sequence of hyperlinks 92.

Tabs 90 and hyperlinks 92 may also be referred to as display items, and different types of display items may be used in alternative embodiments. In the example embodiment, the screens and underlying functionality may be implemented as a set of related HTML documents, JAVA scripts, etc. However, alternative embodiments may use different technologies to provide the same or similar functionality.

Network installation manager 80 may determine the predetermined sequence for presenting the display items by reference to the XML file with the customized installation instructions for SAN 10. By selecting, in sequence, the tabs and the hyperlinks for the different tasks within each tab, the user may obtain customized guidance for installing the various network components into an operational network.

For instance, after viewing information about planning the installation, the user may select the “Installation” tab to reveal hyperlinks 92. The user may then select each hyperlink in the left column in sequence for instructions on installing the various component of SAN 10. In the example embodiment, the screen content associated with the “Installation” tab includes a left column with a heading for “SAN Management” and a heading for “SAN Components.” The options under “SAN Management” include a hyperlink leading to instructions for installing the “Management Station,” a hyperlink leading to instructions for “Managed Node Installation,” and a “Custom” for instructions on installing additional network components, such as switches 20 and 22 and storage enclosures 30 and 31. The options under “SAN Components” include a hyperlink to view instructions for “Software Installation” and an option to view “Release Notes.”

Referring also to FIG. 4, in response to user interaction (e.g., a mouse click) selecting each option under “SAN Management” in sequence, network installation manager 80 may display customized instructions 84 explaining how the various devices should be cabled together, as indicated at block 214. An individual at the customer site may then deploy and connect the devices according to those instructions, as indicated at block 216.

Then, in response to user interaction selecting the “Software Installation” option, network installation manager 80 may display a screen with display items that represent the installed hardware components, for example in the form of a block diagram or a sequential, hierarchical list of expandable items. In response to user interaction with those display items, network installation manager 80 may then push software packages 85 to the devices, as indicated at block 218.

For instance, in the example embodiment, the user may ‘right click’ on a topology item, and based on the item's connections, network installation manager 80 may display a list of possible node types for said item. The user may then select the desired type and click on the install button. In response, network installation manager 80 may cause the SAN components needed to configure said type to be pushed to and installed on that physical item. Network installation manager 80 may thus provide installation guidance for multiple applications. Furthermore, network installation manager 80 may allow the user to manually customize the software installation procedure, by allowing the user to “drill down” into display items to interact with specific components in SAN 10.

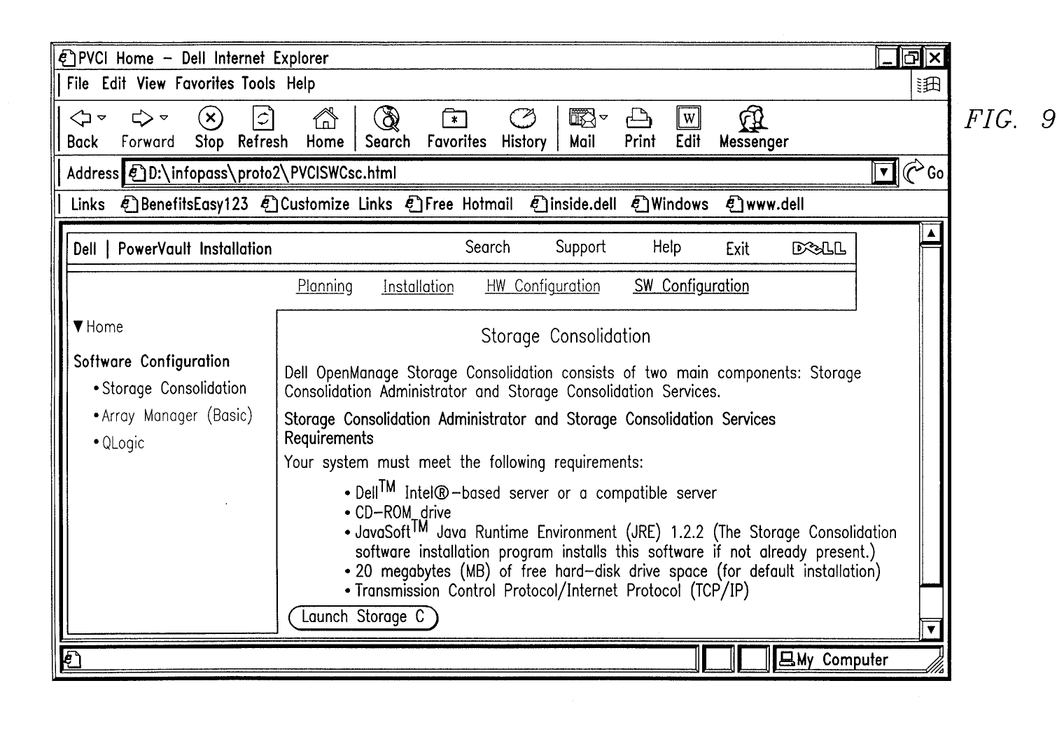

At block 220, after the hardware has been connected and the software installed, the “Hardware Configuration” tab may lead to screens that allow the user to validate the network hardware in real time. At block 222, the user may then push hardware settings from configuration parameters 86 to devices in SAN 10. At block 223, the user may then select the “Software Configuration” tab, and network installation manager 80 may then push software settings from configuration parameters 86 to devices in SAN 10. In addition, as shown in FIG. 9, the options under the “Software Configuration” tab may allow the user to launch the software that has been pushed to the devices and configured, as described above.

Network installation manager 80 may also provide an option to validate SAN 10 after configuration parameters 86 have been distributed, as indicated at block 224. For instance, XML validation rules 82 may be included in network installation package 78, and network installation manager 80 may use XML validation rules 82 to validate SAN 10. For instance, network installation manager 80 may retrieve device attributes from the various devices and cross reference the discovered attributes with the known good attributes to determine whether the devices have valid attributes. For example, network installation manager 80 may compare a firmware revision level discovered on a device with a known good revision level for that firmware.

Similarly, validation engine 90 may also determine whether SAN 10 conforms to specific hardware interconnect rules. For example, there may be a limit to the number of hosts that are supported in a network. Alternatively, certain hardware components may not operate correctly when used in the same network. A network may also be constrained with respect to cable types (e.g., optical vs. copper) for certain interconnections, network zoning, and connection restrictions (e.g., either policy or physical limits). These are all examples of some different types of hardware interconnect rules that may be included in XML validation rules 82 and verified by network installation manager 80 to determine whether SAN 10, or a specific device or connection in SAN 10, is valid.

As indicated at block 226, once SAN has been validated, network installation manager 80 may generate an XML file describing the specific hardware and software configuration of SAN 10 and save that XML file for future reference. In addition, the customer may print software documentation 120 and a network topology diagram 122 for SAN 10 to be left with the customer for future reference, as indicated in FIG. 3. The guided installation process may then end.

However, when the user is considering changing SAN 10, the user may execute network installation manager 80 and call up planning module 81 to obtain guidance. Planning module 81 may be used in creating a new SAN or upgrading/adding to an already configured SAN. If the user is configuring a new SAN layout, he or she may use the planning tool for guidance in selecting the desired hardware pieces. SAN rules from install library 110 may be referenced for this topology, so that the user is always insured a supported configuration.

If the user determines that additional hardware should be ordered, the user may request an export list from planning module 81. In response, and an export engine 83 in planning module 81 may generate an export list that contains a list of the existing hardware and software items and a list of the hardware items to be added. The export list may also describe the topology of the existing network and the desired topology incorporating the items to be added. The user may then e-mail the export file to a sales representative or transmit it directly to sales application 114, for instance via the Internet.

When the vendor receives the export list from the customer, the vendor may then evaluate the additional hardware components in the export list for suitability with the existing components in and topography of SAN 10. NIP manager 112 may also automatically identify software components to accompany the additional hardware components, based on the export list. In addition, NIP manager 112 may generate an updated network installation package that includes those software components. The vendor may then deliver to the customer the additional hardware components and the updated network installation package with the software components for those hardware components In addition, the vendor may occasionally certify revised lists of approved characteristics, and the vendor may provide customers with corresponding updates to network installation packages. For instance, the vendor may make the updates available via the Internet.

In conclusion, the present invention relates to a network installation package that facilitates network installation. Although the present invention has been described with reference to an example embodiment, those with ordinary skill in the art will understand that numerous variations of the example embodiment could be practiced without departing from the scope and spirit of the present invention. For example, the hardware and software components depicted in the example embodiment, including the various data files, represent functional elements that are reasonably self-contained so that each can be designed, constructed, or updated substantially independently of the others. In alternative embodiments, however, it should be understood that the components may be implemented using other arrangements or other combinations of hardware and software. In alternative embodiments, information handling systems incorporating the invention may include personal computers, mini computers, mainframe computers, distributed computing systems, and other suitable devices.

Alternative embodiments of the invention also include computer-usable media encoding logic such as computer instructions for performing the operations of the invention. Such computer-usable media may include, without limitation, storage media such as floppy disks, hard disks, CD-ROMs, read-only memory, and random access memory; as well as communications media such wires, optical fibers, microwaves, radio waves, and other electromagnetic or optical carriers. The control logic may also be referred to as a program product.

Many other aspects of the example embodiment may also be changed in alternative embodiments without departing from the scope and spirit of the invention. The scope of the invention is therefore not limited to the particulars of the illustrated embodiment or implementation but is defined by the appended claims.

What is claimed is:

1. A method of facilitating build-to-order processing of customer orders for network components, the method comprising:
providing a customer with a network installation package that includes (a) an network installation manager which guides installation of a network containing a first set of network components, (b) a planning module which guides the customer in selecting additional hardware components to be added to the network, and (c) an export engine which generates an export list describing the additional hardware components selected by the customer to be added to the network;
receiving the export list from the customer;
evaluating the additional hardware components in the export list for suitability with the network;
automatically identifying software components to accompany the additional hardware components, based on the export list; and
providing the customer with the additional hardware components and the identified software components.

2. The method of claim 1, wherein providing the customer with the identified software components comprises providing the customer with an updated network installation package that includes the identified software components.

3. The method of claim 1, further comprising:
before providing the customer with the network installation package, receiving a customer order that identifies the devices in the first set of network components; and
automatically generating customized installation instructions for the network installation package, based on the customer order and a library of installation guidelines, wherein the customized installation instructions explain how to install the first set of network components.

4. A method of facilitating network installation, the method comprising:
automatically generating customized installation instructions for installing a network, based on a list of devices to be included in the network and a library of installation guidelines;
automatically identifying multiple software packages, multiple documentation packages, and configuration parameters for two or more of the devices to be included in the network, based on the list of devices and the library of installation guidelines;
storing the customized installation instructions, the multiple software packages, the multiple documentation packages, and the configuration parameters in a network installation package; and
sending the network installation package to a customer, for use in installing the network.

5. The method of claim 4, wherein:
the library of installation guidelines comprises a library of statements encoded in a markup language;
automatically identifying multiple software and documentation packages comprises using the library of statements to automatically determine which software packages and which documentation packages are to be included in the network installation package; and
automatically generating customized installation instructions comprises:
automatically determining a preferred sequence for installing the software packages, based on the library of statements; and
including an explanation of the preferred sequence for installing the software packages in the customized installation instructions.

6. The method of claim 4, further comprising an operation of including validation logic in the network installation package, the validation logic operable to validate the network and display validation results.

7. The method of claim 4, wherein the operation of storing the customized installation instructions, the multiple software packages, the multiple documentation packages, and the configuration parameters in the network installation package comprises:
including software, documentation, and configuration parameters for multiple types of network devices in the network installation package.

8. The method of claim 4, wherein storing the customized installation instructions, the multiple software packages, the multiple documentation packages, and the configuration parameters in a network installation package comprises:
storing the network installation package on a removable data storage medium, whereby the network installation package may be loaded from the removable data storage medium into a workstation.

9. The method of claim 4, further comprising making the network installation package available for the customer via a wide area network.

10. The method of claim 4, further comprising:
generating an update for the network installation package; and
making the update available for the customer via a wide area network.

11. A method of facilitating network installation, the method comprising:
creating a network installation package that includes documentation, software, configuration parameters, and network installation instructions for multiple network devices, wherein the software and configuration parameters have been pre-validated as successfully interoperating in a test network;
loading the network installation package into a workstation in a network;
displaying, in the workstation, hardware deployment instructions from the network installation instructions, wherein the hardware deployment instructions describe how to connect additional devices to the network;
displaying, in the workstation, data items that correspond to the additional devices;
in response to user interaction with one or more of the data items, pushing software and configuration parameters from the workstation via a network connection to the additional devices that correspond to the one or more data items; and
in response to additional user interaction with the one or more data items, launching the software that was pushed to the additional devices.

12. The method of claim 11, wherein:
loading the network installation package into a workstation in a network comprises loading the network installation package into a management station in a storage area network;
displaying the hardware deployment instructions comprises displaying instructions that describes how to connect managed nodes to the storage area network; and
pushing software and configuration parameters from the workstation to the additional devices comprises pushing software and configuration parameters from the management station to the managed nodes.

13. The method of claim 11, further comprising the operation of using the network installation package as an exclusive source for documentation and software for initial installation and configuration of the network.

14. The method of claim 11, further comprising the operation of using the network installation package to ensure that hardware setup, software installation, and device configuration for the network are correct and complete.

15. A program product for facilitating network installation, the program product comprising:
a computer-usable medium; and
a network installation package encoded in the computer-usable medium, wherein the network installation package includes:
documentation, software, configuration parameters, and network installation instructions for multiple network devices, wherein the software and configuration parameters have been pre-validated as successfully interoperating in a test network;
a network installation manager containing computer instructions which, when executed, perform operations comprising:
displaying, in a workstation in a network, at least one deployment instruction from the network installation instructions describing how to connect additional devices to the network;
displaying, in the workstation, data items that correspond to the additional devices;
in response to user interaction with one or more of the data items, pushing software and configuration parameters from the workstation via a network connection to the additional devices that correspond to the one or more data items; and
in response to additional user interaction with the one or more data items, launching the software that was pushed to the additional devices.

16. The program product of claim 15, wherein:
the network installation manager guides installation of a first set of network components for the network; and
the network installation package further comprises:
a planning module which guides a customer in selecting additional hardware components to be added to the network; and
an export engine which generates an export list describing the additional hardware components selected by the customer to be added to the network, such that the export list may be used by a vendor to automatically identify software components to accompany the additional hardware components.

17. The program product of claim 15, wherein:
the workstation comprises a management station in the network;
the additional devices comprise managed nodes in the network; and
the operation of pushing software and configuration parameters from the workstation to the additional devices comprises pushing software and configuration parameters from the management station to managed nodes.

18. The program product of claim 15, wherein the network installation package comprises an exclusive source for documentation and software for initial installation and configuration of the network.

19. An information handling system for facilitating network installation, the information handling system comprising:
processing resources, including a computer-usable medium and a network connection;
a network installation package encoded in the computer-usable medium;
documentation in the network installation package for multiple network devices;
software in the network installation package for the multiple network devices;
configuration parameters in the network installation package for the multiple network devices, wherein the software and the configuration parameters have been pre-validated as successfully interoperating in a test network;
network installation instructions in the network installation package; and
a network installation manager in the network installation package, the network installation manager containing computer instructions which, when executed, perform operations comprising:
displaying, in the information handling system, assembly instructions from the network installation instructions describing how to connect additional devices to the network;
displaying, in the information handling system, data items that correspond to the additional devices;
in response to user interaction with one or more of the data items, pushing software and configuration parameters from the information handling system via the network connection to the additional devices that correspond to the one or more data items; and
in response to additional user interaction with the one or more data items, launching the software that was pushed to the additional devices.

20. The information handling system of claim 19, wherein:
the information handling system comprises a management workstation that runs the network installation manager; and
the additional devices comprises workstations to be configured during installation to operate as managed nodes.
